(19) United States
(12) Patent Application Publication
(10) Pub. No.: US 2026/0015268 A1
(43) Pub. Date: Jan. 15, 2026

(54) Method of Controlling Total Organic Carbon in Reverse Osmosis Systems

(71) Applicant: Ecolab USA Inc., St. Paul, MN (US)

(72) Inventors: Seong-Hoon Yoon, Naperville, IL (US); Ning Jin, Shanghai (CN)

(73) Assignee: Ecolab USA Inc., St. Paul, MN (US)

(21) Appl. No.: 19/262,493

(22) Filed: Jul. 8, 2025

Related U.S. Application Data
(60) Provisional application No. 63/668,817, filed on Jul. 9, 2024.

(51) Int. Cl. C02F 1/58; C02F 1/50; C02F 1/70; C02F 1/76; C02F 101/38

(52) U.S. Cl. CPC C02F 1/58; C02F 1/50; C02F 1/70; C02F 1/76; C02F 2101/38; C02F 2209/44

(57) ABSTRACT

The invention provides a method of reducing urea concentration in a reverse osmosis permeate, the method comprising: treating feed water of a reverse osmosis process with hypobromite to provide hypobromite-treated feed water with reduced urea concentration relative to the untreated feed water, optionally reducing residual oxidizing halogen species in the hypobromite-treated feed water with a reducing agent, activated carbon, ultraviolet (UV) light, or a combination thereof, adding an oxidative biocide to the hypobromite-treated feed water to provide biocide-treated feed water, and contacting the biocide-treated feed water with a reverse osmosis membrane to provide the reverse osmosis permeate.

### CROSS-REFERENCE TO RELATED APPLICATIONS

This application claims priority to U.S. Provisional Patent Application No. 63/668,817, filed Jul. 9, 2024, which is incorporated by reference herein in its entirety.

### BACKGROUND OF THE INVENTION

Obtaining a low concentration of total organic carbon (TOC) using a reverse osmosis (RO) membrane is an important step in an ultrapure water (UPW) process for producing UPW. Unlike most naturally occurring organics (e.g., humic acids, fulvic acids, biopolymers, etc.), which are easily removed by RO, urea cannot be removed effectively by RO, exhibiting only about 20% removal efficiency [Yoon et al., Journal of Membrane Science, 261, 76-86 (2005)]. Once urea passes through the RO membrane, there are no downstream mechanisms in conventional ultrapure water (UPW) processes to efficiently remove urea from the RO permeate. In that respect, electrodeionization (EDI), ion exchange column chromatography, ultraviolet (UV) light, and ultrafiltration (UF) membranes, while efficient at removing other contaminants from the RO permeate, do not efficiently remove urea.

Urea is present in natural water resources and the concentration of urea fluctuates with season and region. Even at low part per billion (ppb) concentrations in UPW, urea is known to have a negative impact on modern photolithography processes since urea naturally decomposes into ammonia, which in-turn impacts the performance of photoresists. Thus, there exists a need for methods to reduce the urea concentration prior to RO in the preparation of UPW for industries such as, for example, the microelectronic industry.

There is also a need for methods to reduce biofouling of the RO membrane of UPW production processes. In that respect, biofilms formed on the RO membrane surface not only reduce membrane permeability, but also reduce contaminant removal efficiency [Suresh et al., Journal of Environmental Chemical Engineering, 11 (3): 110317 (2013)].

In view of the foregoing, there remains a need for methods to remove urea from RO feed water and reduce biofouling of the RO membrane in the preparation of UPW. The invention provides such methods. These and other advantages of the invention, as well as additional inventive features, will be apparent from the description of the invention provided herein.

### BRIEF SUMMARY OF THE INVENTION

The invention provides a method of reducing urea concentration in a reverse osmosis permeate, the method comprising: treating feed water of a reverse osmosis process with hypobromite to provide hypobromite-treated feed water with reduced urea concentration relative to the untreated feed water, adding an oxidative biocide to the hypobromite-treated feed water to provide biocide-treated feed water, and contacting the biocide-treated feed water with a reverse osmosis membrane to provide the reverse osmosis permeate.

The invention also provides a method of reducing urea concentration in a reverse osmosis permeate, the method comprising: treating feed water of a reverse osmosis process with hypobromite to provide hypobromite-treated feed water with reduced urea concentration relative to the untreated feed water, reducing residual oxidizing halogen species in the hypobromite-treated feed water with a reducing agent, activated carbon, ultraviolet (UV) light, or a combination thereof, adding an oxidative biocide to the hypobromite-treated feed water to provide biocide-treated feed water, and contacting the biocide-treated feed water with a reverse osmosis membrane to provide the reverse osmosis permeate.

### DETAILED DESCRIPTION OF THE INVENTION

The invention provides a method of reducing urea concentration in a reverse osmosis permeate, the method comprising: treating feed water of a reverse osmosis process with hypobromite to provide hypobromite-treated feed water with reduced urea concentration relative to the untreated feed water, optionally reducing residual oxidizing halogen species in the hypobromite-treated feed water with a reducing agent, activated carbon, ultraviolet (UV) light, or a combination thereof, adding an oxidative biocide to the hypobromite-treated feed water to provide biocide-treated feed water, and contacting the biocide-treated feed water with a reverse osmosis membrane, e.g., passing the biocide-treated feed water through a reverse osmosis membrane, to provide the reverse osmosis permeate.

Without wishing to be bound by any particular theory, it is believed that the reduced contaminant removal efficiency results from reduced contaminant back-diffusion from the membrane surface inside of the biofilm. In that respect, normally, rejected contaminant accumulate on the membrane surface but can back-diffuse into the bulk water due to concentration gradients. However, biofouling creates a confined space where diffusion is significantly slower, thereby trapping contaminants within the biofilm and effectively increasing the concentration of the contaminants at the membrane surface. As a result, more contaminants pass through the RO membrane, thereby compromising the RO membrane performance. Thus, keeping the RO membrane surface free of biofouling is essential to ensuring high-quality RO permeate and high RO membrane productivity.

Thus, in some embodiments, the method of reducing urea concentration in a reverse osmosis permeate may include treating feed water of a reverse osmosis process with hypobromite to provide hypobromite-treated feed water with reduced urea concentration relative to the untreated feed water, adding an oxidative biocide to the hypobromite-treated feed water to provide biocide-treated feed water, and contacting the biocide-treated feed water with a reverse osmosis membrane to provide the reverse osmosis permeate.

The feed water of the reverse osmosis process can be treated with hypobromite by any suitable method. For example, the hypobromite can be formed in situ in the feed water of the reverse osmosis process from a chlorine source and a bromide source or the hypobromite can be formed by reacting a chlorine source and a bromide source separately from the feed water (e.g., in a separate aqueous solution) before treating the feed water with the hypobromite (e.g., the aqueous hypobromite solution) produced thereby. In preferred embodiments, the hypobromite is formed in situ from a chlorine source and a bromide source in the feed water.

Regardless of whether the hypobromite is formed (i) in situ or (ii) as a separate aqueous solution and subsequently add to the feed water of the reverse osmosis process, the hypobromite is formed from a chlorine source and a bromide source. The chlorine source can be any suitable compound containing one or more chlorine atoms in a neutral oxidation state (e.g., Cl₂) or chlorine in a positive oxidation state (e.g., chlorite). In some embodiments, the chlorine source comprises a chlorite salt or chlorine (Cl₂). Suitable chlorite salts include, but are not limited to sodium hypochlorite, potassium hypochlorite, calcium hypochlorite, or a combination thereof. In some embodiments, the chlorine source comprises chlorine (Cl₂). In certain embodiments, the chlorine source comprises a chlorite salt selected from sodium hypochlorite, potassium hypochlorite, calcium hypochlorite, and a combination thereof. The bromide source can be any suitable compound containing one or more bromine atoms in a (−1) oxidation state. In some embodiments, the bromide source comprises a bromide salt (e.g., aluminum bromide, calcium bromide, iron bromide, lithium bromide, magnesium bromide, potassium bromide, sodium bromide, zinc bromide, etc.). In some embodiments, the bromide salt comprises sodium bromide, potassium bromide, calcium bromide, magnesium bromide, iron bromide, aluminum bromide, or a combination thereof.

In some embodiments, the method comprises determining (e.g., measuring) the urea concentration in the feed water prior to treating the feed water of the reverse osmosis process with hypobromite. The urea concentration in the feed water can be manually determined using techniques known in the art (e.g., photometrically or colorimetrically) or can be determined using an automated in-line sensor.

Generally, the feed water of the reverse osmosis process may be treated with at least about a 3-fold molar excess (e.g., 3-fold to 10-fold molar excess, 3-fold to 5-fold molar excess, or 3-fold to 4-fold molar excess) of hypobromite relative to the concentration of urea in the feed water. For example, the feed water of the reverse osmosis process may be treated with at least about a 3.1-fold molar excess (e.g., 3.1-fold to 10-fold molar excess, 3.1-fold to 5-fold molar excess, or 3.1-fold to 4-fold molar excess), at least about a 3.5-fold molar excess (e.g., 3.5-fold to 10-fold molar excess, 3.5-fold to 5-fold molar excess, or 3.5-fold to 4-fold molar excess), or at least about a 4-fold molar excess (e.g., 4-fold to 10-fold molar excess or 4-fold to 5-fold molar excess) of hypobromite relative to the concentration of urea in the feed water. In some embodiments, when the urea concentration in the feed water is about X ppm, the feed water is treated with at least about 3.1 X ppm (e.g., 3.1 X ppm to 10 X ppm, 3.1 X ppm to 5 X ppm, or 3.1 X ppm to 4 X ppm) hypobromite. In certain embodiments, when the urea concentration in the feed water is about X ppm, the feed water is treated with at least about 3.5 X ppm (e.g., 3.5 X ppm to 10 X ppm, 3.5 X ppm to 5 X ppm, or 3.5 X ppm to 4 X ppm) hypobromite.

The hypobromite can be formed from any suitable amount of the chlorine source and any suitable amount of the bromide source. Generally, a molar excess of the bromide source relative to the chlorine source is preferable. Thus, in some embodiments, the hypobromite is formed by reacting a molar excess of the bromide source relative to the chlorine source.

Treating the feed water of the reverse osmosis process with hypobromite according to the invention provides hypobromite-treated feed water with reduced urea concentration relative to the untreated feed water. The urea concentration in the hypobromite-treated feed water may be reduced by any suitable amount relative to the untreated feed water. In some embodiments, the urea concentration in the hypobromite-treated feed water is reduced by at least about 50% relative to the untreated feed water, for example, at least about 60% relative to the untreated feed water, at least about 70% relative to the untreated feed water, at least about 80% relative to the untreated feed water, at least about 90% relative to the untreated feed water, at least about 95% relative to the untreated feed water, or at least 99% relative to the untreated feed water. Alternatively, or additionally, the urea concentration in the hypobromite-treated feed water may be reduced to about 100 ppb or less, for example, about 50 ppb or less, about 20 ppb or less, about 10 ppb or less, about 5 ppb or less, or about 1 ppb or less.

The method of reducing urea concentration in a reverse osmosis permeate further comprises adding an oxidative biocide to the hypobromite-treated feed water to provide biocide-treated feed water. The oxidative biocide can be any suitable biocide having the ability to kill a microorganism through the electrochemical process of oxidation. For example, the oxidative biocide may include a nitrogen-bound halide (e.g., a nitrogen-bound chlorine, a nitrogen-bound bromine, or a nitrogen-bound iodine), a peroxide (e.g., hydrogen peroxide, a peracid, or a combination thereof. In some embodiments, the oxidative biocide includes chlorosulfamate, bromosulfamate, chloroglycine, hydrogen peroxide, performic acid, peracetic acid, perpropionic acid, perbutyric acid, or a combination thereof. In certain embodiments, the oxidative biocide includes chlorosulfamate, bromosulfamate, or a combination thereof.

In some embodiments, the oxidative biocide is added at least about 5 minutes (e.g., from about 5 minutes to about 48 hours) after the feed water is treated with hypobromite. Thus, the invention includes embodiments wherein the period from when treating feed water of the reverse osmosis process with hypobromite is ended until addition of the oxidative biocide to the hypobromite-treated feed water is started is at least about 5 minutes (e.g., about 5 minutes to about 48 hours, about 5 minutes to about 24 hours, about 5 minutes to about 12 hours, about 5 minutes to about 6 hours, or about 5 minutes to about 4 hours), for example, greater than about 30 minutes (e.g., about 30 minutes to about 48 hours, about 30 minutes to about 24 hours, about 30 minutes to about 12 hours, about 30 minutes to about 6 hours, or about 30 minutes to about 4 hours), greater than about 2 hours (e.g., about 2 hours to about 48 hours, about 2 hours to about 24 hours, about 2 hours to about 12 hours, about 2 hours to about 6 hours, or about 2 hours to about 4 hours), greater than about 4 hours (e.g., about 4 hours to about 48 hours, about 4 hours to about 24 hours, about 4 hours to about 12 hours, or about 4 hours to about 6 hours), greater than about 6 hours (e.g., about 6 hours to about 48 hours, about 6 hours to about 24 hours, or about 6 hours to about 12 hours). Without wishing to be bound by any particular theory, it is believed that the oxidative biocide performance is enhanced by the bromide ions formed as a result of the urea reacting with hypobromite.

Thus, it has been found that allowing sufficient time for the urea in the reverse osmosis feed water to react with the hypobromite not only fully reduces the urea concentration in the feed water, but also generates bromide ions for enhancing the biocide performance. It has thus been found that the oxidative biocide and hypobromite act synergistically to reduce urea concentration and minimize membrane fouling in a reverse osmosis process. In some embodiments, the period from when treating feed water of the reverse osmosis process with hypobromite is ended until addition of the oxidative biocide to the hypobromite-treated feed water is started is from about 5 minutes to about 48 hours. In some embodiments, the period from when treating feed water of the reverse osmosis process with hypobromite is ended until addition of the oxidative biocide to the hypobromite-treated feed water is started is from about 2 hours to about 48 hours. In certain embodiments, the period from when treating feed water of the reverse osmosis process with hypobromite is ended until addition of the oxidative biocide to the hypobromite-treated feed water is started is from about 4 hours to about 48 hours.

In some embodiments, the method of the invention further comprises reducing residual oxidizing halogen species in the hypobromite-treated feed water with a reducing agent, activated carbon, ultraviolet (UV) light, or a combination thereof. Thus, the invention also provides a method of reducing urea concentration in a reverse osmosis permeate, which method includes: treating feed water of a reverse osmosis process with hypobromite to provide hypobromite-treated feed water with reduced urea concentration relative to the untreated feed water, reducing residual oxidizing halogen species in the hypobromite-treated feed water with a reducing agent, activated carbon, ultraviolet (UV) light, or a combination thereof, adding an oxidative biocide to the hypobromite-treated feed water to provide biocide-treated feed water, and contacting the biocide-treated feed water with a reverse osmosis membrane to provide the reverse osmosis permeate. The oxidizing halogen species may be reduced before or after adding an oxidative biocide to the hypobromite-treated feed water to provide biocide-treated feed water and contacting the biocide-treated feed water with a reverse osmosis membrane. In some embodiments, the oxidizing halogen species is reduced before adding an oxidative biocide to the hypobromite-treated feed water to provide biocide-treated feed water and contacting the biocide-treated feed water with a reverse osmosis membrane.

As used here, the term “residual oxidizing halogen species” refers to any oxidizing halogen species remaining in the hypobromite-treated feed water after treating the feed water with hypobromite. For example, the residual oxidizing halogen species may include chlorine (Cl₂), hypochlorite, chlorate, bromine (Br₂), hypobromite, bromate, or a combination thereof.

The residual oxidizing halogen species may be reduced with a reducing agent, activated carbon, ultraviolet (UV) light, or a combination thereof. In some embodiments, the method includes reducing residual oxidizing halogen species in the hypobromite-treated feed water with a reducing agent. The reducing agent may be any suitable compound capable of reducing one or more of chlorine (Cl₂), hypochlorite, chlorate, bromine (Br₂), hypobromite, and bromate. In some embodiments, the reducing agent includes a sulfite salt, a bisulfite salt, a metabisulfite, or a thiosulfate salt. For example, the reducing agent may include sodium sulfite, sodium bisulfite, sodium metabisulfite, sodium thiosulfate, potassium sulfite, potassium bisulfite, potassium metabisulfite, or potassium thiosulfate.

As used herein, “water” refers to any substance that includes water as a primary ingredient. Water may include, for example, purified water, tap water, fresh water, recycled water, brine, steam, and/or any aqueous solution, an aqueous blend, and the like. Typically, the water treated in the reverse osmosis process is feed water of a reverse osmosis process.

The reverse osmosis process may be used to purify water for any suitable application. For example, the reverse osmosis process may be used in a process for converting water (e.g., industrial wastewater) to ultrapure water (UPW). In some embodiments, the reverse osmosis process is used in a process for converting industrial wastewater to ultrapure water (UPW). In certain embodiments, the reverse osmosis process may be used in a process for converting water (e.g., industrial wastewater) to ultrapure water (UPW) for use in a microelectronic industry such as, for example, a semiconductor fabrication plant.

As used herein, “industrial wastewater” refers to wastewater from any system that circulates water as part of an industrial or industrially applicable process. Non-limiting examples of industrial water systems include, e.g., cooling systems, boiler systems, heating systems, paper making processes, or any other systems that move or circulate water as part of an industrial or industrially applicable process.

Aspects, including embodiments, of the invention described herein may be beneficial alone or in combination, with one or more other aspects or embodiments described herein. Certain non-limiting embodiments of the disclosure numbered 1-21 are provided below. As will be apparent to those of skill in the art upon reading this disclosure, each of the individually numbered embodiments may be used or combined with any of the other individually numbered embodiments described herein. This is intended to provide support for all such combinations of embodiments and is not limited to combinations of embodiments explicitly provided below:

### EMBODIMENTS

(1) In embodiment (1) is presented a method of reducing urea concentration in a reverse osmosis permeate, the method comprising: treating feed water of a reverse osmosis process with hypobromite to provide hypobromite-treated feed water with reduced urea concentration relative to the untreated feed water, optionally reducing residual oxidizing halogen species in the hypobromite-treated feed water with a reducing agent, activated carbon, ultraviolet (UV) light, or a combination thereof, adding an oxidative biocide to the hypobromite-treated feed water to provide biocide-treated feed water, and contacting the biocide-treated feed water with a reverse osmosis membrane, e.g., passing the biocide-treated feed water through a reverse osmosis membrane, to provide the reverse osmosis permeate.

(2) In embodiment (2) is presented the method of embodiment (1), wherein the hypobromite is formed in situ from a chlorine source and a bromide source in the feed water, e.g., by adding a chlorine source and a bromide source to the feed water.

(3) In embodiment (3) is presented the method of embodiment (1), wherein the hypobromite is formed by reacting a chlorine source and a bromide source separately from the feed water before treating the feed water with the hypobromite produced thereby.

(4) In embodiment (4) is presented the method of embodiment (2) or (3), wherein the chlorine source comprises a chlorite salt or chlorine (Cl2).

(5) In embodiment (5) is presented the method of embodiment (4), wherein the chlorite salt comprises sodium hypochlorite, potassium hypochlorite, calcium hypochlorite, or a combination thereof.

(6) In embodiment (6) is presented the method of any one of embodiments (2)-(5), wherein the bromide source comprises a bromide salt.

(7) In embodiment (7) is presented the method of embodiment (6), wherein the bromide salt comprises sodium bromide, potassium bromide, calcium bromide, magnesium bromide, iron bromide, aluminum bromide, or a combination thereof.

(8) In embodiment (8) is presented the method of any one of embodiments (1)-(7), wherein the urea concentration in the feed water is about X ppm, and the feed water is treated with at least about 3.1 X ppm hypobromite.

(9) In embodiment (9) is presented the method of embodiment (8), wherein the urea concentration in the feed water is about X ppm, and the feed water is treated with at least about 3.5 X ppm hypobromite.

(10) In embodiment (10) is presented the method of any one of embodiments (2)-(9), wherein the hypobromite is formed by reacting a molar excess of the bromide source relative to the chlorine source.

(11) In embodiment (11) is presented the method of any one of embodiments (2)-(10), wherein the period from when treating feed water of the reverse osmosis process with hypobromite is ended until addition of the oxidative biocide to the hypobromite-treated feed water is started is from about 5 minutes to about 48 hours.

(12) In embodiment (12) is presented the method of embodiment (11), wherein the period from when treating feed water of the reverse osmosis process with hypobromite is ended until addition of the oxidative biocide to the hypobromite-treated feed water is started is from about 2 hours to about 48 hours.

(13) In embodiment (13) is presented the method of embodiment (12), wherein the period from when treating feed water of the reverse osmosis process with hypobromite is ended until addition of the oxidative biocide to the hypobromite-treated feed water is started is from about 4 hours to about 48 hours.

(14) In embodiment (14) is presented the method of any one of embodiments (1)-(13), comprising reducing residual oxidizing halogen species in the hypobromite-treated feed water with a reducing agent, activated carbon, ultraviolet (UV) light, or a combination thereof.

(15) In embodiment (15) is presented the method of embodiment (14), wherein the oxidizing halogen species comprises chlorine (Cl2), hypochlorite, chlorate, bromine (Br2), hypobromite, bromate, or a combination thereof.

(16) In embodiment (16) is presented the method of embodiment (14), wherein the reducing agent comprises a sulfite salt, a bisulfite salt, a metabisulfite, or a thiosulfate salt.

(17) In embodiment (17) is presented the method of embodiment (16), wherein the reducing agent comprises sodium sulfite, sodium bisulfite, sodium metabisulfite, sodium thiosulfate, potassium sulfite, potassium bisulfite, potassium metabisulfite, or potassium thiosulfate.

(18) In embodiment (18) is presented the method of any one of embodiments (1)-(17), wherein the oxidative biocide comprises a nitrogen-bound halide, a peroxide, a peracid, or a combination thereof.

(19) In embodiment (19) is presented the method of embodiment (18), wherein the oxidative biocide comprises chlorosulfamate, bromosulfamate, chloroglycine, hydrogen peroxide, performic acid, peracetic acid, perpropionic acid, perbutyric acid, or a combination thereof.

(20) In embodiment (20) is presented the method of embodiment (19), wherein the oxidative biocide comprises chlorosulfamate, bromosulfamate, or a combination thereof.

(21) In embodiment (21) is presented the method of any one of embodiments (1)-(20), wherein the reverse osmosis process is used in a process for converting industrial wastewater to ultrapure water.

### EXAMPLES

The following examples further illustrate the invention but, of course, should not be construed as in any way limiting its scope.

### Example 1

This example provides an exemplary protocol for reducing urea concentration in a reverse osmosis permeate and minimizing membrane fouling in a reverse osmosis process.

The urea concentration in the reverse osmosis (RO) feed water is determined. Based on the urea concentration in the RO feed water, sodium hypochlorite (NaOCl) is added or chlorine (Cl₂) is sparged to achieve a free chlorine concentration in the RO feed water of at least 3.54 times the urea concentration in the RO feed water. The NaOCl or chlorine may be added automatically or manually and the level of free chlorine can be monitored using an online sensor or a chemical test such as N,N-diethyl-p-phenylenediamine (DPD).

Sodium bromide (or the like) is added to the RO feed water to achieve an excess of bromide ion relative to free chlorine and a concentration of at least 4 times the urea concentration in the RO feed water, thereby generating hypobromite in situ.

Alternatively, the sodium hypochlorite (NaOCl) or chlorine (Cl₂) and sodium bromide (or the like) may be combined in a separate aqueous solution to generate hypobromite, and the resulting aqueous solution may be added to RO feed water.

Hypobromite (e.g., at least 3 times the urea concentration in the RO feed water) is added until all, or almost all, of the urea in the RO feed water is consumed. Consumption of the urea in the RO feed water may take as long as 6 hours (e.g., 12 hours or 24 hours).

Once the urea in the RO feed water is consumed, the residual oxidizing halogen species (e.g., free chlorine, chlorine (Cl₂), hypochlorite, chlorate, bromine (Br₂), hypobromite, and/or bromate) may be reduced by adding/using, for example, activated carbon, ultraviolet (UV) light, or reducing agents. Typically, the residual oxidizing halogen species are reduced below 0.05 ppm.

Chlorosulfamate and/or bromosulfamate is added to the RO feed water as a biocide treatment to reduce fouling (e.g., biofilm fouling) of the RO membrane. Without wishing to be bound by any particular theory, it is believed that the oxidative biocide (e.g., chlorosulfamate and/or bromosulfamate) performance is enhanced by the bromide ions formed as a result of the urea reacting with hypobromite. In this way, the oxidative biocide and hypobromite act synergistically to reduce urea concentration and minimize membrane fouling in a reverse osmosis process.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of reducing urea concentration in a reverse osmosis permeate, the method comprising:
treating feed water of a reverse osmosis process with hypobromite to provide hypobromite-treated feed water with reduced urea concentration relative to the untreated feed water,
optionally reducing residual oxidizing halogen species in the hypobromite-treated feed water with a reducing agent, activated carbon, ultraviolet (UV) light, or a combination thereof,
adding an oxidative biocide to the hypobromite-treated feed water to provide biocide-treated feed water, and
contacting the biocide-treated feed water with a reverse osmosis membrane to provide the reverse osmosis permeate.

2. The method of claim 1, wherein the hypobromite is formed in situ from a chlorine source and a bromide source in the feed water.

3. The method of claim 1, wherein the hypobromite is formed by reacting a chlorine source and a bromide source separately from the feed water before treating the feed water with the hypobromite produced thereby.

4. The method of claim 2, wherein the chlorine source comprises a chlorite salt or chlorine (Cl₂).

5. The method of claim 4, wherein the chlorite salt comprises sodium hypochlorite, potassium hypochlorite, calcium hypochlorite, or a combination thereof.

6. The method of claim 2, wherein the bromide source comprises a bromide salt.

7. The method of claim 6, wherein the bromide salt comprises sodium bromide, potassium bromide, calcium bromide, magnesium bromide, iron bromide, aluminum bromide, or a combination thereof.

8. The method of claim 1, wherein the urea concentration in the feed water is about X ppm, and the feed water is treated with at least about 3.1 X ppm hypobromite.

9. The method of claim 8, wherein the urea concentration in the feed water is about X ppm, and the feed water is treated with at least about 3.5 X ppm hypobromite.

10. The method of claim 2, wherein the hypobromite is formed by reacting a molar excess of the bromide source relative to the chlorine source.

11. The method of claim 2, wherein the period from when treating feed water of the reverse osmosis process with hypobromite is ended until addition of the oxidative biocide to the hypobromite-treated feed water is started is from about 5 minutes to about 48 hours.

12. The method of claim 11, wherein the period from when treating feed water of the reverse osmosis process with hypobromite is ended until addition of the oxidative biocide to the hypobromite-treated feed water is started is from about 2 hours to about 48 hours.

13. The method of claim 1, comprising reducing residual oxidizing halogen species in the hypobromite-treated feed water with a reducing agent, activated carbon, ultraviolet (UV) light, or a combination thereof.

14. The method of claim 13, wherein the oxidizing halogen species comprises chlorine (Cl₂), hypochlorite, chlorate, bromine (Br₂), hypobromite, bromate, or a combination thereof.

15. The method of claim 13, wherein the reducing agent comprises a sulfite salt, a bisulfite salt, a metabisulfite, or a thiosulfate salt.

16. The method of claim 15, wherein the reducing agent comprises sodium sulfite, sodium bisulfite, sodium metabisulfite, sodium thiosulfate, potassium sulfite, potassium bisulfite, potassium metabisulfite, or potassium thiosulfate.

17. The method of claim 1, wherein the oxidative biocide comprises a nitrogen-bound halide, a peroxide, a peracid, or a combination thereof.

18. The method of claim 17, wherein the oxidative biocide comprises chlorosulfamate, bromosulfamate, chloroglycine, hydrogen peroxide, performic acid, peracetic acid, perpropionic acid, perbutyric acid, or a combination thereof.

19. The method of claim 18, wherein the oxidative biocide comprises chlorosulfamate, bromosulfamate, or a combination thereof.

20. The method of claim 1, wherein the reverse osmosis process is used in a process for converting industrial wastewater to ultrapure water.
